(19) United States
(12) Patent Application Publication
(10) Pub. No.: US 2008/0219389 A1
(43) Pub. Date: Sep. 11, 2008

(54) Feed-forward cancellation in wireless receivers

(75) Inventor: John Nisbet, Nepean (CA)

Correspondence Address: FREEDMAN & ASSOCIATES, 117 CENTREPOINTE DRIVE, SUITE 350, NEPEAN, ONTARIO, K2G 5X3, CA

(73) Assignee: SiGe Semiconductor Inc., Ottawa (CA)

(21) Appl. No.: 11/714,199

(22) Filed: Mar. 6, 2007

(51) Int. Cl. H04L 1/00

(52) U.S. Cl. 375/348

(57) ABSTRACT

A method of suppressing interference from remote transmitters operating to a first standard having frequencies overlapping those for a receiver operating to a second standard is provided. Such interference being increasingly common as a result of the deployment of multiple wireless transceivers within electronic devices either supporting multiple international standards, such as WiFi and WiMAX, or within typical wireless environments. Advantageously, the invention presents a means of actively cancelling interference from transmitters operating within the same frequency range as defined by the standard. The active cancellation accordingly allows improved performance for systems with very low received signal powers, such as GPS, in addition to wireless data communications standards. An exemplary embodiment providing active cancellation through delaying the portion of the received signal according to the first standard adjusting both the amplitude and phase by means of polar modulation prior to summing this signal with the received signal to provide a receive signal within which the first standard signal is nulled. Control of the polar modulator being determined in the exemplary embodiment by minimizing received power after passband limiting filters.

### FIELD OF THE INVENTION

The invention relates to cancelling interference within wireless receivers from wireless transmitters operating on overlapping standards, and more particularly to integrated circuit implementations.

### BACKGROUND OF THE INVENTION

In recent years, the use of wireless and RF technology has increased dramatically in portable and hand-held units, where such units are deployed by a variety of individuals from soldiers on the battlefield to a mother searching for her daughter's friend's house. The uses of wireless technology are widespread, increasing, and include but are not limited to telephony, Internet e-mail, Internet web browsers, global positioning, photography, and in-store navigation. Additionally, devices incorporating wireless technology have expanded to include not only cellular telephones, but Personal Data Analyzers (PDAs), laptop computers, palmtop computers, gaming consoles, printers, telephone headsets, portable music players, point of sale terminals, global positioning systems, inventory control systems, and even vending machines.

The wireless infrastructure for these devices can support data, voice and other services on multiple standards, examples include but are not limited to:
WiFi [ANSI/IEEE Standard 802.11, “Wireless LAN Medium Access Control (MAC) and Physical Layer (PHY) Specifications,” Reaffirmed 2003];
WiMAX [IEEE Standard 802.16, “Air Interface for fixed Broadband Wireless Access Systems,” 2004];
Bluetooth [IEEE Standard 802.15.1, “Wireless Medium Access Control (MAC) and Physical Layer (PHY) Specifications for Wireless Personal Area Networks (WPANS),” Reaffirmed 2005]; and
ZigBee [IEEE Standard 802.15.4, “Wireless Medium Access Control (MAC) and Physical Layer (PHY) Specifications for Low-Rate Wireless Personal Area Networks (LR-WPANs),” 2003].

WiFi (WLAN) communication has enjoyed overwhelming consumer acceptance worldwide, generally as specified in IEEE 802.11a (operating in the frequency range of 4900-5825 MHz) or IEEE 802.11b and IEEE 802.11g specifications (operating in the range 2400-2485 MHz). These standards seem destined to survive and thrive in the future, for example with the IEEE 802.11n MIMO physical layer. The 802.11 value proposition is the provision of low cost, moderate data communication/transport rates and simple network function.

WiMAX (WMAN) communication is also preparing to deploy massively worldwide, especially as IEEE 802.16e (operating at two frequency ranges, the first being 2300-2690 MHz, and the second of 3300-3800 MHz). The IEEE 802.16e value proposition is the provision of moderate cost and high data communication/transport rates at high quality of service, which requires higher system performance and complexity.

As a result, it is highly likely that many applications and devices will occur where there is need to either support both WiMAX and WiFi services, such as two transceivers within a single device typically being co-located a few centimeters apart, or provide sustained operation within a multi-transmitter environment. As such a potential difficulty arises if the IEEE 802.16e WiMAX transceiver tries to operate in the first, lower frequency band of 2300-2690 MHz, and is co-located or close to an IEEE 802.11b/g WiFi transceiver. Although the IEEE 802.16e spectrum is segmented, into two bands, the lower 2300-2397.5 MHz and upper 2496-2690 MHz, these straddle the IEEE 802.11b/g band of 2400-2485 MHz closely, giving negligible guard bands of unused spectrum between the two services to prevent mutual interference.

Furthermore, although IEEE 802.16e transceivers employ transmit/receive duplexing this is synchronized “globally” throughout the area served by each base station, the transmit/receive duplexing of IEEE 802.11b/g transceivers is negotiated locally with each independent network access point. As there may be many IEEE 802.11b/g network access points within the transmission zone of one IEEE 802.16e base station, and the two systems operate completely independently. The co-located units will therefore see a varying combination of IEEE 802.11b/g or IEEE 802.16e transmitters/receivers at any given time.

At present, there are no aspects of these IEEE 802.11b/g and IEEE 802.16e standards that address the collocation and interaction/interference of such collocated systems. Considering prior art approaches to removing interference of multiple transceivers, then solutions would appear to be time separation, frequency separation, filtering, passive interference, and localized device control. Considering these in order:

Time Separation: An exemplary embodiment of time separation would be to force IEEE 802.11 devices not to transmit whilst an IEEE 802.16 device receiving, or vice-versa. However, this requires the Media Access Control (MAC) and higher layers of the WiFi and WiMAX systems to interact, which is not facilitated within existing systems, and would fundamentally reduce aggregate throughput in both systems;

Frequency Separation: An exemplary embodiment of frequency separation would be to provide “bar” operation, and thereby clear, frequency bands within both IEEE 802.11 and IEEE 802.16 systems near the band boundaries. However, frequency separation wastes spectrum in one or both systems and reduces aggregate throughput;

Filtering: Filtering and/or duplexing the IEEE 802.11 and IEEE 802.16 systems away from each other, without impacting aggregate throughput, requiring MAC or higher interactions etc. The limited clearance between the frequency bands of the two systems requires impractically high-order filters. For example, near 2400 MHz the last WiMAX channel is 2397.5 MHZ and the first WiFi channel is 2412 MHz. For an attenuation of ΛdB in the stop band of the filter, with a stop band frequency of ℑ(s), and a passband frequency of ℑ(p) then the order, η, of the required filter is given by:

η=Λ/{20*log[ℑ(s)/ℑ(p)]} (1)

For Λ=30, ℑ(s)=2412 MHz, and ℑ(p)=2397.5 MHz, the required filter order η is 573! Such filters, even if feasible could not be integrated into the low cost semiconductor circuits being provided for the WiFi and WiMAX transceivers, increasing costs, degrading performance, increasing footprint and packaging complexity etc. Further, such filtering cannot filter out IEEE 802.11 (WiFi) leakage because it is in-band for the IEEE 802.16 (WiMAX) receiver;

Passive Interference: Originating from radar infrastructure, the approach introduces a predetermined portion of the transmitted signal from an antenna into the receive path of a collocated second antenna. Whilst, such an approach does not waste spectrum in one or both systems, nor does it reduce aggregate throughput, such approaches within the prior art do not support either a remote transmitter, such as another user within the same coffee shop, nor multiple transmitters, such as several other customers within a coffee shop, such scenarios being typical for today's mobile devices with multiple local transmitters interacting with a receiver. Further the proliferation of multi-standard devices will also increased occurrences where two transceivers are collocated or monolithically integrated.

Localized Device Control. As noted supra the MAC and higher layers of the WiFi and WiMAX systems do not interact at the overall network level. However, it is reasonable to assume that when these two transceivers are within a single device, such as a laptop computer, that the IEEE 801.11b/g and IEEE 801.16e modems are mutually aware as they are probably controlled from the same PCI bus. Hence, a “trick” could be to have either the IEEE 801.11b/g or IEEE 801.16e modems take priority and force the other “off the air” temporarily; essentially an extreme variant of time separation. For example, the IEEE 801.16e modem could “pose” as the closest network access point, force the IEEE 801.11 b/g modem to associate with it on channel 6 (or channel 7 in European installations) and then unassociated after IEEE 801.16e reception is complete. Such association being a logical connection between the mobile station (MS) and access point (AP) which is formally defined within the IEEE 802.11 standard, such associations normally occurring at power on of the MS or when it re-discovers an AP after temporarily losing touch.

The difficulty with this is that it wastes most, or all, of the IEEE 802.11b/g band during the IEEE 802.16e operation. If the WiFi service is forced off the air simply because WiMAX is being used nearby, the bandwidth is available from the point of view of the WiFi AP, but cannot be used by the WiFi MS because of local conditions. Further it imposes additional transmit/receive protocol overhead and complexities into the communications. IEEE 802.11 is designed with a fairly simple arrangement whereby the MS and AP can agree on who will talk or listen at what times, and what information is transmitted in what order. It is not designed to synchronize with any other system and these complexities will result in association and throughput rates being significantly worse than normal design values.

As such none of the prior art approaches provide a solution that does not waste spectrum in one or both systems, nor reduces aggregate throughput. Further, such prior art approaches are particularly adapted to network environments wherein IEEE 802.11b/g and IEEE 802.16e modems are relatively stationary allowing protocols to be established and utilized. However, today's wireless environments are not stationary for significant periods of time, and such networks are projected to become even less so as ad-hoc networking architectures become more common due to the elimination of significant network planning requirements and eliminating significant infrastructure costs. As such portable devices with multi-standard modems (such as IEEE 802.11b/g and IEEE 802.16e) will continually adjust to achieve network access and provide active leakage from one modem to another as the local environment changes.

Furthermore the prior art approaches do not support the emergence of many consumer orientated electronic devices that operate with collocated or spatially close transmitters on multiple standards. Additionally, requirements for an active interference cancellation scheme within such high volume, low cost electronic devices include adapting to changes in the wireless environment, such as the rapid addition of a new transceiver or fast changes in the local environment of the electronic devices and their locations, and compatibility with the integrated circuit chip set providing the transceiver functionality.

It would be further advantageous if the active interference cancellation approach utilized low power control and adaptation techniques to enhance battery lifetime for mobile devices supporting the collocated systems.

### SUMMARY OF THE INVENTION

In accordance with the invention there is provided a method of reducing interference in a receiver, comprising:
providing at least a receiver for receiving a first signal according to a first wireless standard, the receiver comprising at least one band-limiting filter of a plurality of band-limiting filters;
receiving at the receiver a second signal according to a second wireless standard; providing and feeding forward a first cancellation signal, the first cancellation signal being at least a portion of the second signal and having at least one of a predetermined time delay, predetermined amplitude relationship, and predetermined phase relationship with respect to the second signal;
combining the first cancellation signal with the received first signals; and
generating a control signal, the control signal for controlling an aspect of the generation of the first cancellation signal and being generated in dependence upon a measure of the received signal power after filtering thereof by the band-limiting filters.

In accordance with another embodiment of the invention there is provided a circuit for reducing interference in a receiver, comprising:
at least a receiver for receiving a first signal according to a first wireless standard and a second signal according to a second wireless standard; the receiver comprising at least one band-limiting filter of a plurality of band-limiting filters;
a first cancellation generating circuit for generating and feeding forward a first cancellation signal in response to a control signal, the first cancellation signal being at least a portion of the second signal and having at least one of a predetermined time delay, predetermined amplitude relationship, and predetermined phase relationship with respect to the second signal;
a transmission path for transmitting the first cancellation signal and combining the first cancellation signal with the received first and second signals; and
a control signal output port for providing the control signal for controlling an aspect of the generation of the first cancellation signal and being generated in dependence upon a measure of the received signal power after filtering thereof by the band-limiting filters.

In accordance with another embodiment of the invention there is provided a computer readable medium having stored therein data according to a predetermined computing device format, and upon execution of the data by a suitable computing device a method of improving a receiver is provided, the method comprising:
providing at least a receiver for receiving a first signal according to a first wireless standard, the receiver comprising at least one band-limiting filter of a plurality of band-limiting filters;
receiving at the receiver a second signal according to a second wireless standard; providing and feeding forward a first cancellation signal, the first cancellation signal being at least a portion of the second signal and having at least one of a predetermined time delay, predetermined amplitude relationship, and predetermined phase relationship with respect to the second signal;
combining the first cancellation signal with the received first signals; and
generating a control signal, the control signal for controlling an aspect of the generation of the first cancellation signal and being generated in dependence upon a measure of the received signal power after filtering thereof by the band-limiting filters.

In accordance with another embodiment of the invention there is provided a computer readable medium having stored therein data according to a predetermined computing device format, and upon execution of the data by a suitable computing device a circuit is provided, comprising:
at least a receiver for receiving a first signal according to a first wireless standard and a second signal according to a second wireless standard; the receiver comprising at least one band-limiting filter of a plurality of band-limiting filters;
a first cancellation generating circuit for generating and feeding forward a first cancellation signal in response to a control signal, the first cancellation signal being at least a portion of the second signal and having at least one of a predetermined time delay, predetermined amplitude relationship, and predetermined phase relationship with respect to the second signal;
a transmission path for transmitting the first cancellation signal and combining the first cancellation signal with the received first and second signals; and
a control signal output port for providing the control signal for controlling an aspect of the generation of the first cancellation signal and being generated in dependence upon a measure of the received signal power after filtering thereof by the band-limiting filters.

### BRIEF DESCRIPTION OF THE DRAWINGS

Exemplary embodiments of the invention will now be described in conjunction with the following drawings, in which:

FIG. 1 illustrates an exemplary scenario for collocated mobile communications systems within a device operating according to two different standards.

FIG. 2 illustrates a prior art interference cancellation scheme for wherein the transmitter signal can be provided to the receiver.

FIG. 3 illustrates an exemplary first embodiment of the invention for active cancellation of a WiFi transmitter within a WiMAX receiver.

FIG. 4A illustrates an exemplary spectrum of a WiFi transmission signal from a first system operating simultaneously with a WiMAX transmission signal.

FIG. 4B illustrates an exemplary spectrum of a cancellation null according to an exemplary embodiment of the invention positioned to align with the WiFi transmission signal from a first system operating simultaneously with a WiMAX transmission signal.

FIG. 5 illustrates an exemplary spectrum of a WiFi transmission signal from a first system operating simultaneously with a WiMAX transmission signal wherein a cancellation null according to an embodiment of the invention is aligned with the second signal.

FIG. 6 illustrates an exemplary two-dimensional binary search for the optimum coefficients of the coefficient engine driving a Cartesian modulator providing the amplitude and phase adjustment of the transmitter signal applied to cancel the transmitter leakage.

FIG. 7 illustrates an exemplary flow diagram for calibrating an active cancellation circuit according to an embodiment of the invention for transmission frequencies of the WiFi standard.

FIG. 8 illustrates an exemplary embodiment of the invention wherein multiple cancellation elements are provided for actively cancelling the WiFi leakage onto a WiMAX receiver.

FIG. 9A illustrates an exemplary embodiment for actively cancelling the leakage between a WiMAX transmitter and a GPS receiver.

FIG. 9B illustrates the power spectral density spectrum for a system operating according to the embodiment presented in respect of FIG. 9A.

### DETAILED DESCRIPTION OF EMBODIMENTS OF THE INVENTION

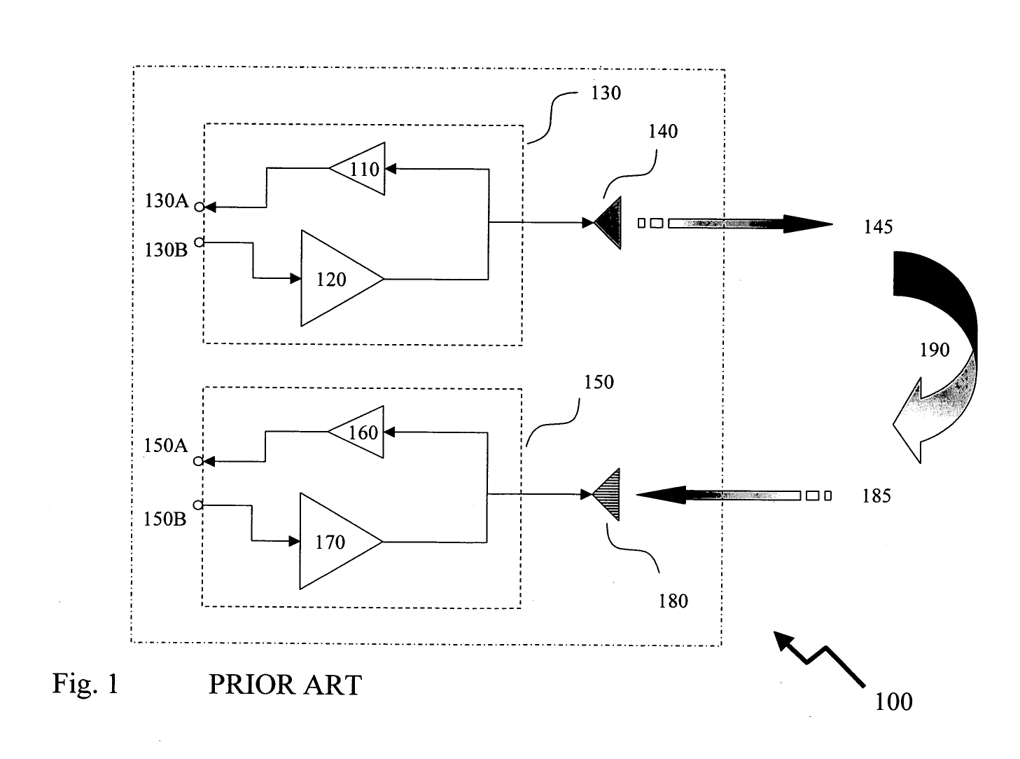

FIG. 1 illustrates an exemplary scenario for transmitter interference from a WiFi transceiver 130 to a WiMAX transceiver 150, both transceivers being located within a single device 100.

As shown the WiFi transceiver 130 comprises a WiFi antenna 140, for receiving and transmitting data over the WiFi carrier 145 according to an IEEE 802.11b or an IEEE 802.11g standard operating in the range 2400-2485 MHz. Shown for the WiFi transceiver 130 are transmit signal input port 130B, which receives the data for transmission encoded onto the appropriate channel within the WiFi frequency range, and is coupled to the WiFi power amplifier 120 for boosting and feeding forward to the WiFi antenna 140. The WiFi antenna 140 is also coupled to a WiFi receiver amplifier 110, which receives WiFi signals from the WiFi antenna 140, boosts them with low noise and high gain due to the low received power and couples this signal to the WiFi receiver port 130A.

Also the WiMAX transceiver 150 is electrically coupled to a WiMAX antenna 180, for receiving and transmitting data over the WiMAX carrier 185, according to the IEEE 802.16e standard, operating at the lower of the two frequency ranges, 2300-2690 MHz. Shown for the WiMAX transceiver 150 are transmit signal input port 150B, which receives the data for transmission encoded onto the appropriate channel within the WiMAX frequency range, and is coupled to the WiMAX power amplifier 170 for boosting and feeding forward to the WiFi antenna 180. The WiFi antenna 180 is also coupled to a WiMAX receiver amplifier 160, which receives WiMAX signals from the WiMAX antenna 180, boosts them with low noise and high gain due to the low received power and couples this signal to the WiMAX receiver port 150A.

Within the representative embodiment when the WiFi transceiver 130 and WiMAX transceiver 150 are within a single device 100, the spacing between antennae is often small, on the order of a few centimeters. Therefore leakage from the WiFi antenna 140 into the WiMAX antenna 180 can occur, giving rise to issues for the receiver as WiMAX receive signals are now interfered with high power interference from the WiFi signal within the same frequency range. Further, placement of the multi-standard single device 100 increases this leakage, for example placement of the single device 100 on a table surface, close to a users head, and next to a window. Each of these and other common placements results in dynamic adjustment in the leakage from one antenna to another. Further, it would be apparent that within other embodiments where a device only houses the WiMAX transceiver 150, interference from local WiFi transceivers within other devices, and even the local base station, could arise.

A typical implementation of WiFi transceiver 130 and WiMAX transceiver 150 within a multi-standard single device 100 is such that the WiFi transceiver 130 operates at +18 dBm according to the IEEE 801.11b/g standard, and that the WiFi antenna 140 and WiMAX antenna 180 are designed as small, cheap, omni-directional antennas that have very little directional or frequency isolation between them, and hence a typical leakage of about 20-25 dB is expected at 2500 MHz. Since both antennas are often fixed with respect to each other and with respect to electrically significant metal and dielectric masses nearby, the WiFi transceiver 130 presents a signal of approximately −2 dBm to the WiMAX transceiver 150, whereas the WiMAX receiver 150 operates with a signal as low as −70 dBm according to the IEEE 802.16e specification. Even other transceivers within the local environment are likely to present sources of interference which even if at −30 dBm is significant with respect to the WiMAX signal levels.

Not only might the WiFi (IEEE 802.11b/g) signal saturate or even potentially overload the WiMAX receiver amplifier 160 but other channel leakages, that are potentially at −30 dBc and −50 dBc, respectively according to IEEE 802.11b, could appear directly in-band for the WiMAX (IEEE 802.16e) signals in some scenarios. As such, these other channel leakages, at −32 dBm and −52 dBm respectively would present an intractable instantaneous dynamic range problem. Such a dynamic range problem is a situation where a wanted signal at very low level is received simultaneously with an interfering signal at much higher level, the dynamic range being the difference between the very low receiver noise floor required to receive the wanted signal and simultaneously the very high receiver distortion threshold required to prevent the interfering signal from clipping the receiver. An intractable dynamic range problem is one in which the interferer is at or near a same frequency as the wanted signal, and therefore cannot be filtered out.

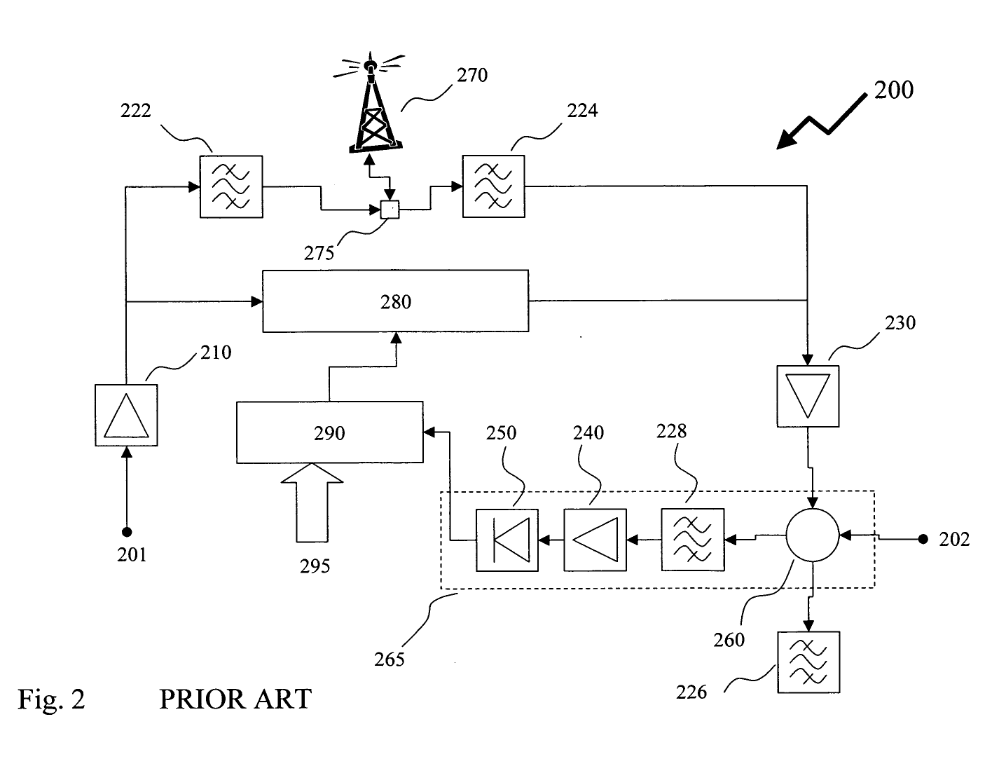

FIG. 2 illustrates a prior art interference cancellation scheme for a duplex transceiver 200 employing a single antenna. 270. The duplex transceiver 200 is implemented for the UMTS standard supporting a full duplex mode unlike the GSM standard. In the UMTS full duplex mode, a chronological overlap between the transmission and reception modes of operation is permitted during operation. A signal for transmission is applied to transmitter port 201 from which it is electrically coupled to the transmitter output power amplifier stage 210. The output signal from the transmitter output power amplifier stage 210 is coupled via a transmission band-transmitting filter 222 and duplexer 275 to the antenna 270 for transmission. A pre-determined portion of the output power of the transmitter output power amplifier stage 210 is coupled to compensation element 280.

A receive signal coupled from the antenna 270 is then coupled via the duplexer 275 to the reception band transmission filter 224. At this point the predetermined portion of the output power of the transmitter output power amplifier stage 210 is applied along with the receive signal from the reception band transmission filter 224 to the reception pre-amplifier 230. The output signal of the reception pre-amplifier 230 is then applied to summation node 260. The reference mixing signal applied to the summation node 260 is coupled from the summation node input port 202. A first output signal of the summation node 260, which is part of a second receiver 265, is then electrically coupled to a simple bandpass filter 226 for subsequent processing and recovery of the encoded data. If we consider the mixing reference signal applied to the summation node port 202 to be ℑ(vco) and the received signal from the reception pre-amplifier 230 to be ℑ(dup) then the signal provided from the simple bandpass filter 226 is given by:

ℑ(itrx)=±ℑ(rx)±ℑ(vco). (1)

A second output signal of the summation node 260 is then coupled to the bandpass filter 228 of the second receiver 265 which provides a signal given by:

ℑ(iftx)=±ℑ(dup)±ℑ(vco). (2)

This signal is then coupled to the second receiver amplifier 240 and a detector 250. The output signal of the detector 250 is an amplitude of the receive signal as measured by the narrowband detection circuit implemented within the second receiver 265. This amplitude of the receive signal is applied to a controller unit 290 which provides control signaling to compensation element 280. Additional control settings are provided to control unit 290 from a control bus port 295.

In operation, the prior art circuit provides an adaptive control based on a voltage measurement at the receiver antenna 270, the compensation element 280 adjusting the phase and amplitude of the transmitted signal in such a way that this measured voltage is minimized. As such the prior art relies upon a predetermined temporal relationship between the “leakage” as a result of contact or close proximity of the antenna to conductive objects or the human body. As such the prior art does not consider any variations within the temporal aspects of the leakage or that leakage causing degradation of reception is other than from the duplex transceiver 270 itself.

It would also be apparent to one skilled in the art that whilst the interference cancellation approach presented in FIG. 2 can be employed to address interference from a co-located transceiver, such as presented in FIG. 1 with the single device 100 housing both WiFi transceiver 130 and WiMAX transceiver 150 this solution cannot handle remote transmitters. Further, the WiFi transceiver 130 and WiMAX transceiver 150 in order to support the additional circuitry and interconnections cannot be existing supplied discrete modules. As such the prior art approach works only with new designs of WiFi transceiver 130 and WiMAX transceiver 150.

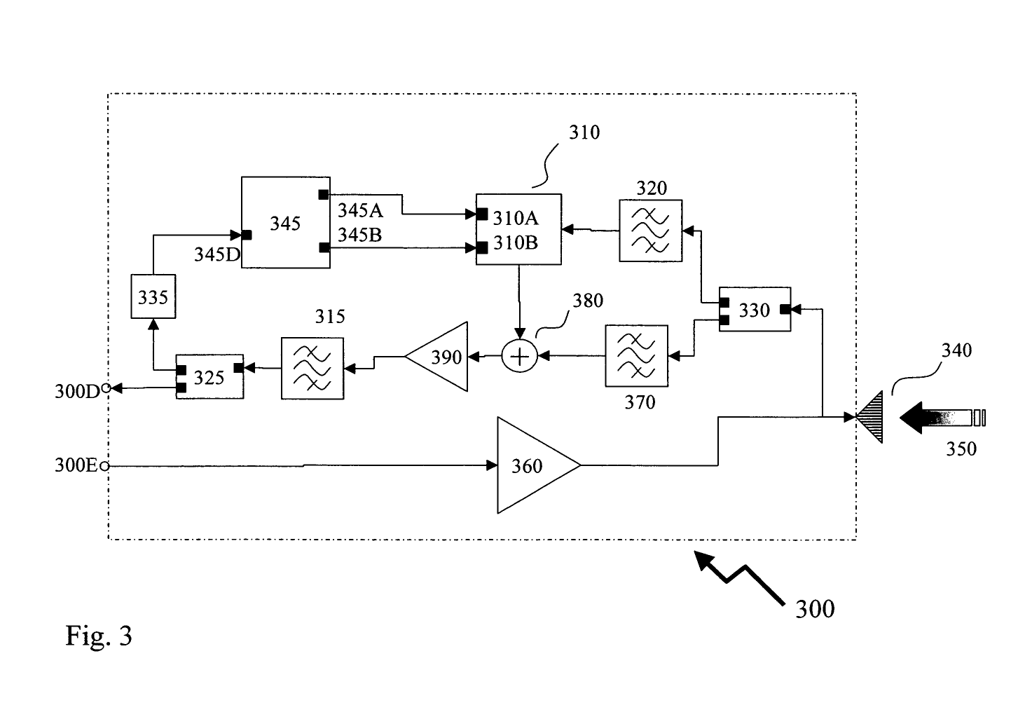

FIG. 3 illustrates a first representative embodiment of the invention for active cancellation of a WiFi transmitter within a WiMAX transceiver 300. As shown the WiMAX transceiver 300 is connected to an antenna 340, which receives wireless signals 350 from the local environment. According to this first representative embodiment the wireless signals 350 comprises WiMAX signals including a desired channel for data in addition to interference from WiFi signals. The WiMAX transceiver 300 receives data for transmission at input port 300E and boosts this with the transmit amplifier 360, which is electrically coupled to the antenna 340.

Signals received from antenna 340 are initially electrically coupled to a splitter 330. A first portion of the received signal is coupled from the splitter 330 to a first filter 370 which has been implemented to provide filtering of the wireless spectrum according to the IEEE 802.16e standard and is operating at the lower of the two frequency ranges, namely 2300-2690 MHz. Such a filter optionally being part of a conventional prior art WiMAX receiver circuit.

From the first filter 370 the filtered wireless signals are fed to the receiver amplifier 390 via a summation node 380 {SJK—perhaps summation node is a better descriptor than mixer throughout}. As such apart from the summation node 380 this signal path representing a typical receiver path of a prior art WiMAX receiver circuit. From the receiver amplifier 390 the amplified received and filter wireless signals are coupled to a second passband limiting filter 315, then to a coupler 325 wherein a portion is directed to a power detector 335, the other port of the coupler 325 being electrically coupled to the output port 300D. The output of the power detector 335 is coupled to a coordinate generator 345 at its input port 345D.

A second portion of the received signal is coupled from the splitter 330 to a second filter 320, which is intended to filter according to the IEEE 802.11b/g standards, and as such is bandpass filter for 2400-2485 MHz. It would be apparent to one skilled in the art that the second filter 320 can be implemented with sharp transition bands due to the relatively small fractional bandwidth of 3.5% (being a bandwidth of 485 MHz at centre frequency of 2442.5 MHz). As such the filter 320 can provide high isolation to WiMAX signals according to the IEEE 802.16e specification within the bands adjacent to the 2400 MHz-2485 MHz region. The WiFi signals passed by the second filter 320 are then electrically coupled to a delay circuit 355, the delay circuit 355 applying an appropriate delay to the second portion of the received signal. The output of the delay circuit 355 is then electrically coupled to a polar modulator 310 that provides adjustment of both the magnitude and phase of signals provided to it, and provides the adjusted output from the polar modulator 310 to the summation node 380. As such the summation node combines the output of the first filter 370, which is a combination of the WiMAX and WiFi signals present within the frequency range 2300-2690 MHz, with the attenuated and phase shifted output of the second filter 320, being the WiFi signals present within the 2400-2485 MHz range. Accordingly it would be apparent that with appropriate adjustment of phase and magnitude by the polar modulator 310 that this mixing results in a cancellation of the signals present within the 2400-2485 MHz region, reducing significantly the interference from these WiFi signals with the desired WiMAX signals.

As shown within FIG. 3 the polar modulator 310 is provided with first and second control inputs at ports 310A and 310B, and the delay circuit 355 is provided with a control input at port 355A. The first control signal port 310A is electrically connected to a first output port of the coordinate generator 345, which is port 345A. The second control signal port 310B is electrically connected to a second output port of the coordinate generator 345, which is port 345B. The control port 355A of the delay circuit 355 is electrically connected to the third output port of the coordinate generator 345, which is port 345A. In this exemplary embodiment therefore the coordinate generator 345 controls the polar modulator 310 such that the measured power at the power detector 335 is reduced, thereby minimizing the interfering signal within the WiMAX receiver. {As with the feed-forward there is in principle no collocated transmitter then I would assume no TXEN signal available. The nearest equivalent would be setting a threshold for the power within the feed-forward portion which is being adjusted by the polar modulator . . . but have added an element in text to cover either scenario)

It would be apparent to one skilled in the art that the invention provides for the cancellation of the interfering WiFi signal presented within the wireless signals 350 received by the antenna 340. The feed-forward cancellation approach outlined within this first embodiment advantageously requiring no communication with interfering transmitters, may be implemented with standard circuit elements such as a WiFi bandpass filter for the second filter 320 and a polar modulator 310. The polar modulator 310 further advantageously presenting a means of providing the required amplitude and phase adjustment with low power consumption, a requirement of mobile device applications.

The polar modulator 310 provides modulation of a signal in a manner analogous to quadrature modulation but relying on polar co-ordinates, r (amplitude) and θ (phase). Whereas quadrature modulators require a linear RF power amplifier, creating a design conflict between improving power efficiency or maintaining amplifier linearity, this is not a limitation within polar modulation, which allows highly non-linear amplifier architectures to be employed with high power efficiency. Such amplifiers are useful as polar modulation operates with an input signal of the amplifier of “constant envelope”, i.e. containing no amplitude variations. Hence, amplitude control is achieved by directly controlling the gain of the power amplifier, which is not undertaken in amplitude modulation wherein the amplifier is operated at fixed gain.

In a polar modulation system, the power amplifier input signal varies only in phase. Amplitude modulation is then accomplished by directly controlling the gain of the power amplifier. Thus a polar modulator allows the use of highly non-linear power amplifier architectures such as Class E and Class F, these being highly efficient switching power amplifiers.

A first benefit of this active cancellation arrangement is that the WiFi interference is removed at the input block to the WiMAX receiver, reducing its required instantaneous dynamic range, and sensitivity to the WiMAX signals is not impaired beyond a small thermal penalty imposed by the summation node 380. Beneficially this active cancellation not only addresses leakage from the main lobe of the interferer solving the WiMAX receiver clipping problem, but also spurs and transmitted noise, are at least partially cancelled.

It would be beneficial at this point to address performance limits, as with any physical implementation active cancellation has some performance limits. Thermal noise floor has been mentioned above. The other limits can be understood by realizing that cancellation is essentially a subtraction of two signals to produce an error signal ξ(t) at the input port of the WiMAX receiver amplifier 390, typically a low-noise amplifier (LNA). Considering simplistically that the reference signal is cos (ωt) then ξ(t) can be expressed as:

ξ(t)=cos (ωt)−[α*cos (ω(t−δ))+β)] (3)

Where [α*cos (ω(t−δ))+β] is the cancellation signal provided through the coupler 330, second filter 320 and polar modulator 310 combination. Here ω=2πf, the angular frequency, α is the amplitude scaling of the polar modulator 310, β is the phase shift of the polar modulator, and δ is the delay difference introduced as a result of the WiFi filtered path, comprising second filter 320 and polar modulator 310 to the summation node 380 being different to the delay introduced by the first filter 370 to the summation node 380.

Ideally α=1 and β=d=0; in order to allow a conventional error expression of the amplitude error, A, to be used;

α=10 [symbol] (−A/20) (4)

In this exemplary embodiment, α and β are adjustable by the polar modulator 310, and δ is fixed as a result of the circuit design. If β is adjusted through 360 degrees with reasonable resolution it is always possible to produce a cancellation null at a frequency ωₒ=β/δ. The depth of the null is determined by magnitude α, and the “sharpness” of the null is determined by the delay error d. If the delay error is 0 then α and β are adjustable to a pair of values that provides cancellation at all frequencies. The cancellation, Ψ, in dB is then expressed as:

Ψ=10*log(|ξ(t)|̂2) (5)

such that

Ψ=10*log(1+α²−2*α*cos (β−χδ)) (6)

where (χ=ω−ωₒ) is the frequency offset from the null frequency ωₒ.

Suppose, within the exemplary embodiment of the active cancellation device 300 of FIG. 3 that 20 dB of cancellation is specified across the WiFi band. If the null is placed in the center of the band, maximum frequency offset χ is (2485−2400)/2=42.5 MHz. With a perfect polar modulator, the resulting delay mismatch is about 350 ps. With perfectly matched delays, the resulting polar modulator errors are 0.5 dB and 5 degrees, respectively, for amplitude and phase. These are modest values for monolithically integrated polar modulators compatible with WiMAX integrated circuit technologies.

As discussed in respect of FIG. 3 above the second portion of the received signal is continuously applied at the summation node 380. In some circumstances, such as no active WiFi transmitter, the applied signal from the polar modulator 310 can provide additional noise into the WiMAX channel. Optionally the circuit path provided by the second filter 320, delay circuit 355 and polar modulator 310 may be configured to minimize this noise contribution. Approaches to such minimization including, but not limited to, electrically isolating the second portion from the summation node 380, and establishing the delay circuit 355 and polar modulator 310 at an alternate configuration. The decision for establishing the operational mode for the delay circuit 355 and polar modulator 310 may provided from one of several sources, including but not limited to, a measurement of the received power after the second filter 320, a transmitter enable signal from the interfering transmitter, and network level control protocol signaling.

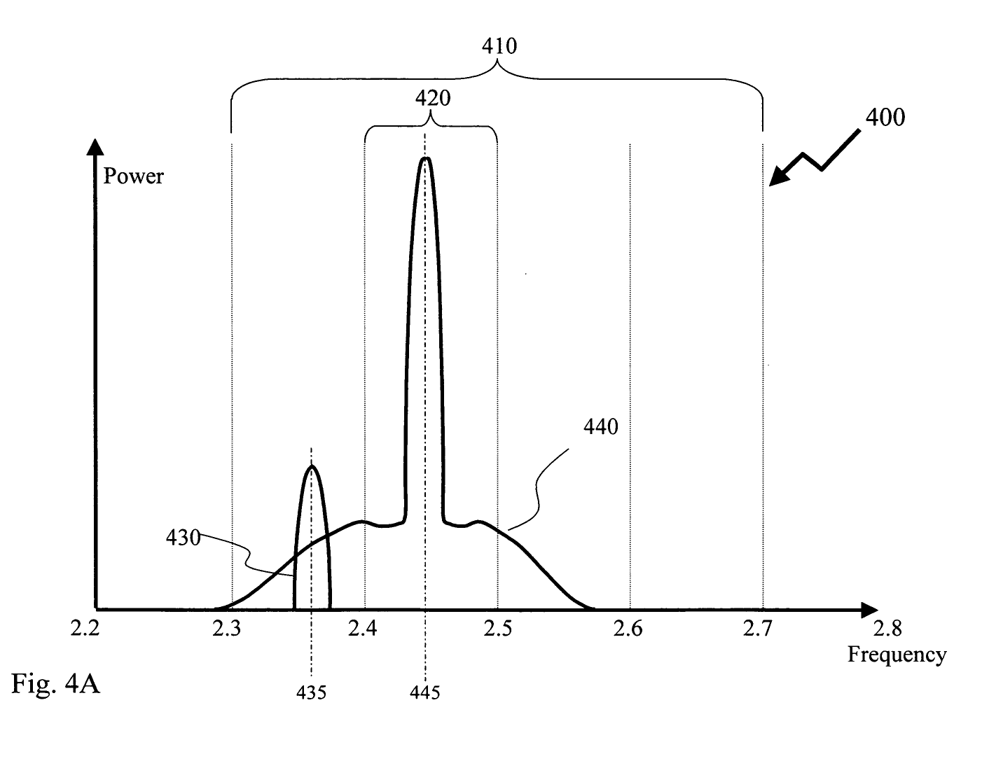

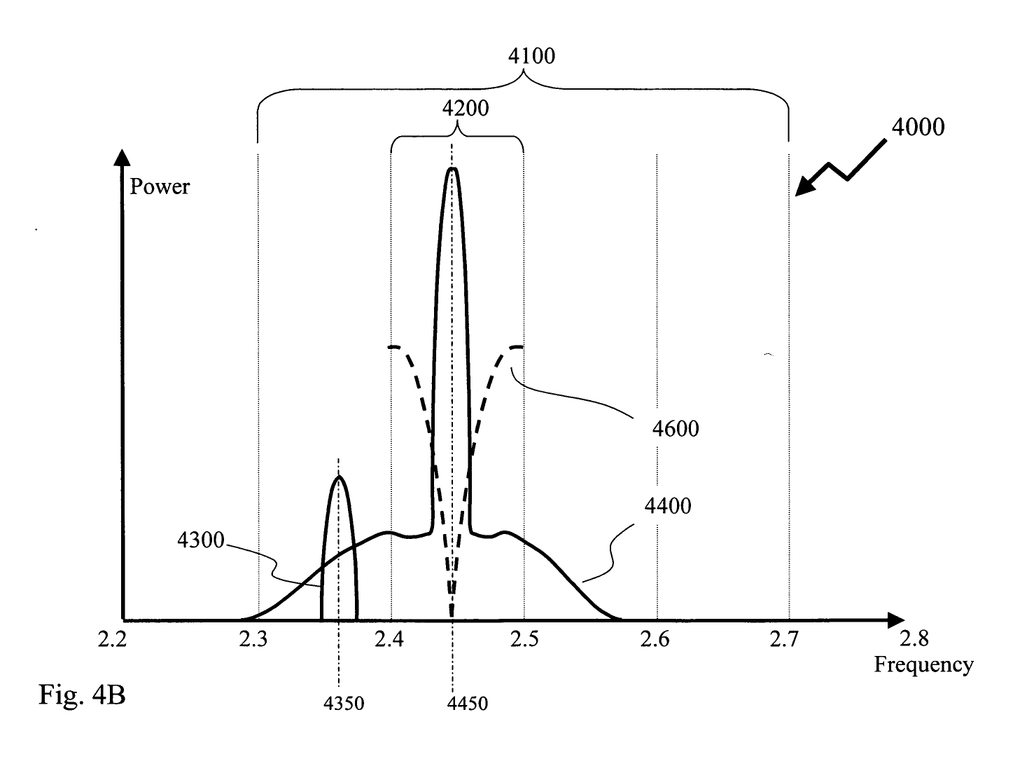

FIG. 4A illustrates an exemplary spectrum 400 of a WiFi transmission signal 440 from a first system operating simultaneously with a WiMAX transmission signal 430 from a second system. As shown, the first transmission signal 440 lies within WiFi window 420 of 2400-2485 MHz and is centered at a frequency 445 that is offset from the WiMAX centre frequency 435 of the transmitter providing the receive signal 430 in the collocated WiMAX second system which is operating within the WiMAX window 410 of 2300-2670 MHz.

FIG. 4B illustrates an exemplary spectrum 4000 of a cancellation null according to an exemplary embodiment of the invention positioned to align with the WiFi transmission signal 4400 from a first system operating simultaneously with a WiMAX transmission signal 4300. As shown, the first transmission signal 4400 lies within WiFi window 4200 of 2400 MHz-2485 MHz and is centered at a frequency 4450 that is offset from the WiMAX centre frequency 4350 of the transmitter providing the receive signal 4300 in the collocated WiMAX second system which is operating within the WiMAX window 4100 of 2300 MHz-2670 MHz. As shown, the cancellation null of the cancellation signal 4600 is centered at the same center frequency 4450 as the WiFi system. Thus the total interferer signal input power is approximately minimized within this exemplary embodiment.

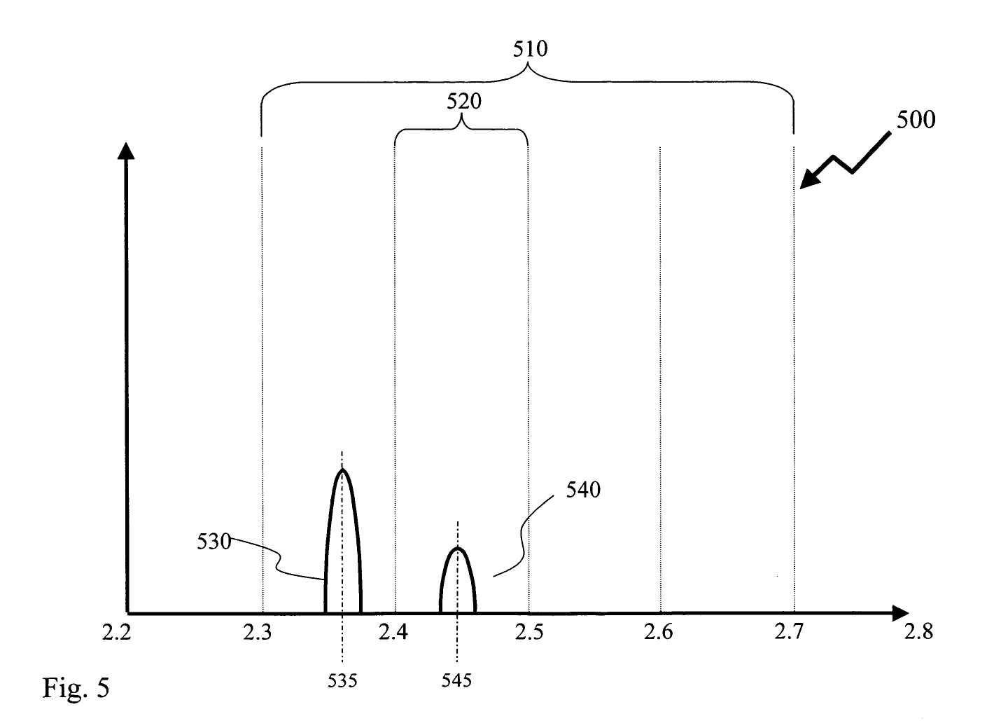

FIG. 5 illustrates an exemplary signal spectrum 5600 fed to a receiver amplifier, such as amplifier 390 of FIG. 3 after corresponding cancellation nulling according to an exemplary embodiment of the invention positioned to align with the WiFi transmission signal 540 from a first system operating simultaneously with a WiMAX transmission signal 530. As shown, the first transmission signal 540 lies within WiFi window 520 of 2400-2485 MHz and is centered at a frequency 545 that is offset from the WiMAX centre frequency 535 of the transmitter providing the receive signal 530 in the collocated WiMAX second system which is operating within the WiMAX window 510 of 2300-2670 MHz. The first transmission signal 540 has now been reduced in magnitude from the received signal, represented by first transmission signal 440 of FIG. 4.

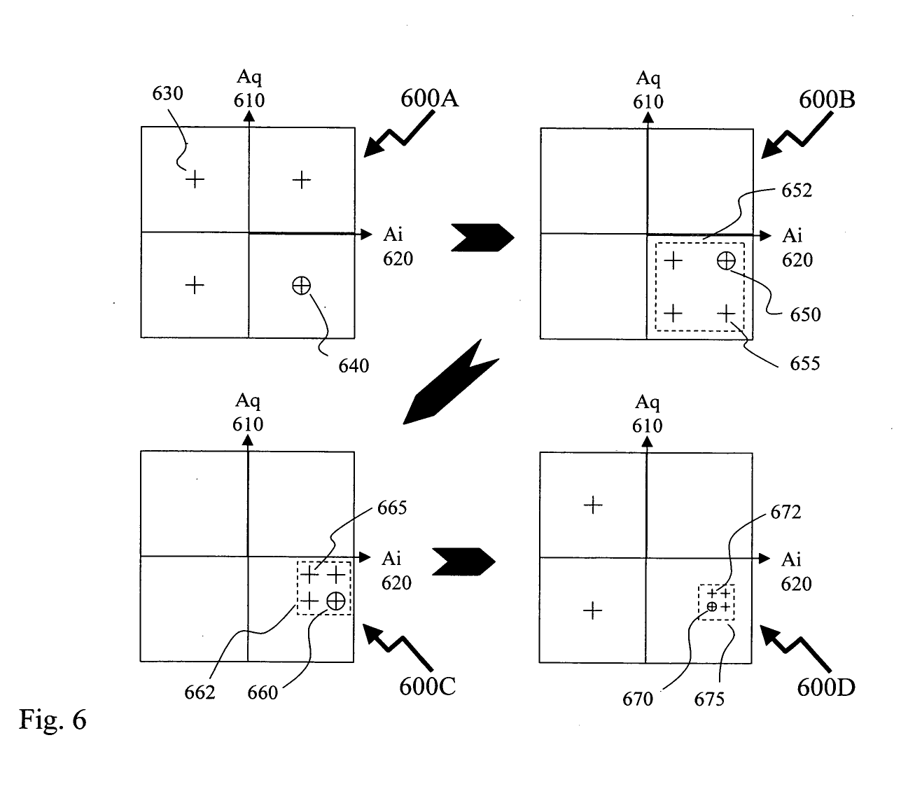

The coordinate generator 345 provides control signals to the polar modulator 310 and delay circuit 355, establishing these settings using a predetermined search algorithm. Considering an exemplary embodiment wherein there the delay circuit 355 has been set to a constant delay, the coordinate generator 345 executes a search algorithm. In the exemplary embodiment of FIG. 6 the coordinate generator 345 executes a two-dimensional search, one of many potential classic algorithms. Shown in FIG. 6 is a first stage search 600A displayed as a two dimensional surface with abscissa Ai 620 representing the amplitude of the in-phase component of the transmitter signal conversion to form the cancellation signal, and ordinate Aq 610 representing the quadrature component. As shown the coordinate generator 345 initially establishes four initial states 630 for the polar modulator 310. From these the preferred initial state 640 provides the lowest Rx detected power as determined from the signal received at the coordinate generator 345 from the Rx power detector 463. As such the preferred initial state 640 is represented by states wherein Ai=1xxx and Aq=0xxx.

The coordinate generator 345 then moves onto second stage 600B, establishing a restricted search space 652 within a quadrant of the two dimensional coordinate space. The four second stage states 655 are established sequentially from which the coordinate generator 345 selects a second preferred state 650 represented by Ai=11xx; Aq=01xx.

Now the coordinate generator 345 then moves onto third stage 600C, establishing a restricted search space 662. Now four third stage states 665 are established sequentially from which the coordinate generator 345 selects a second preferred state 660 represented by Ai=111x; Aq=010x. Finally, in this exemplary embodiment the coordinate engine performs a fourth stage 600D of coordinate refinement. In the further restricted final search space 675 the coordinate generator 345 again establishes four final states 672 and selects the final preferred state 670 representing coordinates Ai=1110 and Aq=0100.

It would be apparent to one skilled in the art that whilst WiFi transceivers, such as WiFi transceiver 130, according to IEEE 802.11b/g, have essentially been commoditized in the past few years, the interference problem with WiMAX transceivers, such as WiMAX transceiver 150, is mutual. Although front-end filters are typically used for the WiFi receiver, the WiMAX out-of-band leakage remains unfilterable and can present a problem. Consider, an example wherein the WiMAX transceiver, such as WiMAX transceiver 150, has an output power of +24 dBm, out-of-band leakage is at −35 dBc and antenna isolation is 20 dB. In this scenario the WiFi transceiver receives WiMAX leakage at −31 dBm. As such, it is evident that cancellation is applicable to each transceiver within a multi-standard device.

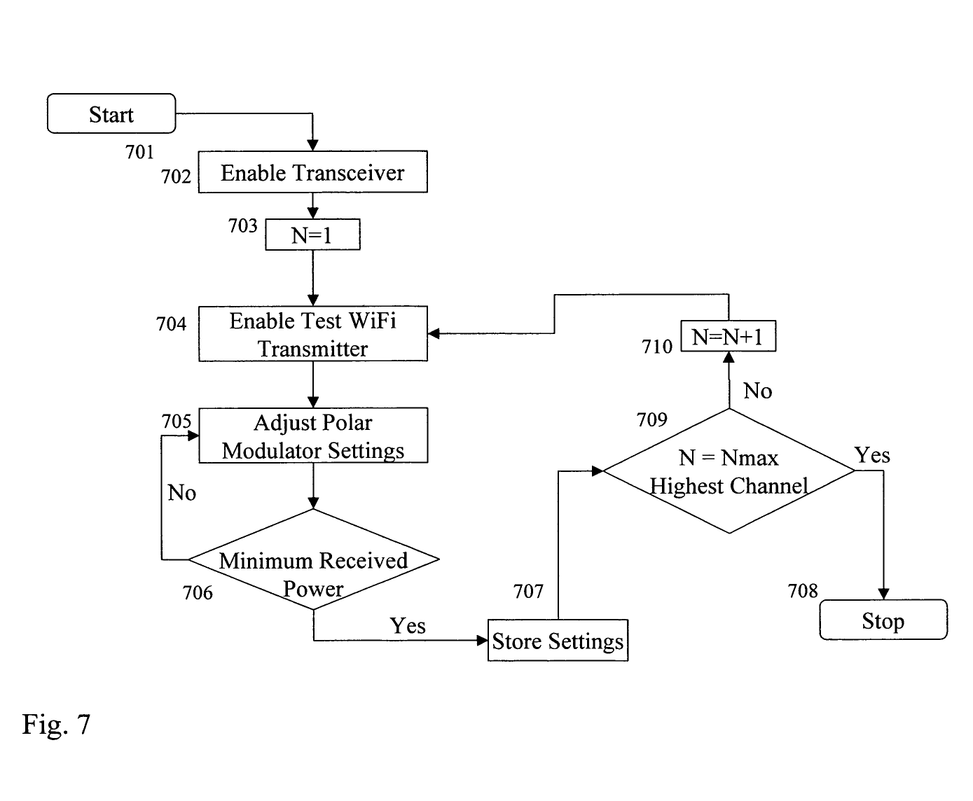

FIG. 7 illustrates an exemplary flow diagram for calibrating an active cancellation circuit according to an embodiment of the invention for transmission frequencies of the WiFi standard. The physical delay and delay mismatch are typically very short in integrated circuit designs, such that cancellation would be over the breadth of the WiFi channel spectrum. However, in certain circumstances such as hybrid designs, or upgrade modules for existing WiMAX transceivers the physical delay and delay mismatch may be significant such that the cancellation null is narrow. In these environments, or in applications where WiMAX signals are being cancelled within a WiFi receiver some calibration of the WiMAX transceiver may be beneficial. In such scenarios a static delay is provided and a calibration process obtains the polar modulator settings, for example. Such a calibration process is shown in FIG. 7.

As shown, upon starting the calibration process at step 701 the WiMAX transceiver is enabled and the WiMAX transmitter disabled. At step 702 a counter value N is set to 1, and a test WiFi transmitter is set to the first channel (N=1) at step 703. With the WiMAX disabled establishing a near optimum polar modulator setting is achieved by determining when minimum RF power is received and detected, through steps 705 and 706, at which point the polar modulator settings are stored in step 707. If the counter N is equal to the highest channel number, step 709, then the calibration is stopped at step 708. If not, the counter N is incremented at step 710, and the calibration cycle repeated for the next channel N+1. In this manner the settings can be stored for each of the WiFi channels allowing the null to be placed on either the sole channel present, or the most significant WiFi transmitter being used, thereby supporting higher values of cancellation. Such an approach optionally including a WiFi channel determination circuit within the transceiver, after the WiFi filter such as first filter 320 of FIG. 3. Optionally, the calibration is updated for a channel, or established initially using a “trickle” calibration. Such a “trickle” calibration is optionally performed during idle times, when the WiMAX transmitter is not actively transmitting signal data for example. Such a “trickle” calibration allows the polar modulator settings to mitigate effects of physical changes in the nearby environment.

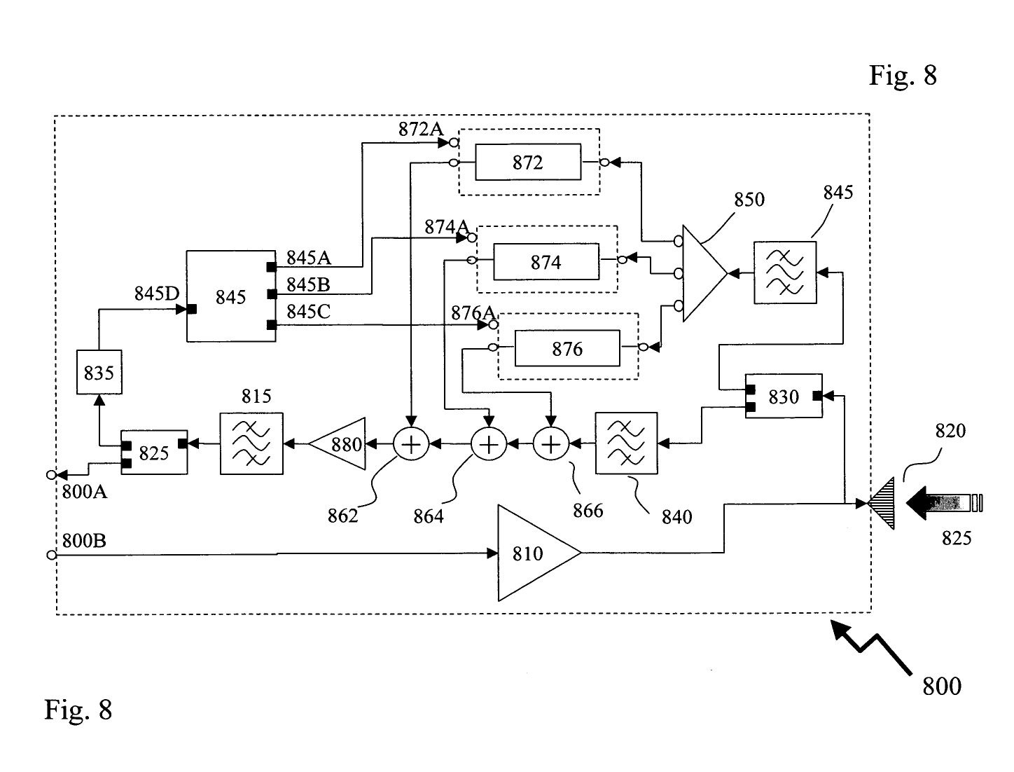

Now referring to FIG. 8 shown is a multiple cancellation transceiver 800 wherein multiple cancellation elements are provided for actively cancelling transmitter interference. As shown the multiple cancellation transceiver 800 comprises an antenna 820, receiving wireless signals 825. The multiple cancellation transceiver 800 receives data to be transmitted at input port 800B and feeds this to the transmit amplifier 810 prior to the antenna 820 for transmission.

The received wireless signals generated within the antenna 820 by the wireless signals 825 are first electrically coupled to splitter 830 that provides two splitter output signals. A first output of the splitter 830 is electrically coupled to the WiMAX bandpass filter 840, and therefrom electrically coupled to the receive amplifier 880 via the sequence of summation node circuits 862, 864 and 866. The second output of the splitter 830 is electrically coupled to the WiFi bandpass filter 845. The WiFi filtered portion of the received wireless signals is then electrically coupled to a second splitter 850, which provides three equal outputs. A first output of the second splitter 850 is electrically coupled to a first cancellation circuit 872, which in this exemplary embodiment comprises a polar modulator, the output of which is coupled to the first summation node circuit 862.

The second output of the second splitter 850 is electrically coupled to a second cancellation circuit 874, similarly comprising a polar modulator, such that the adjusted signal is then coupled to the second summation node circuit 864. The third output of the second splitter 850 is electrically coupled to a third cancellation circuit 876, similarly comprising a polar modulator, such that the adjusted signal is then coupled to the third summation node circuit 866.

The output of the receive amplifier 880 is electrically coupled to a passband limiting filter 815, the output of which is coupled to a second splitter 825. The primary output of the second splitter 825 is then electrically coupled to the receiver output port 800A of the multiple cancellation transceiver 800. The secondary output of second splitter 825 is electrically coupled to a power detector 835, the output of which is coupled to the measurement port 845D of the coordinate generator 845. The coordinate generator 845 provides control of the three cancellation circuits 872, 874 and 876. A first control port 845A of the coordinate generator 845 being coupled to the coordinate port 872A of the first cancellation circuit 872. The second and third control ports 845B and 845C of the coordinate generate 845 being coupled to the second and third cancellation circuits 874 and 876 respectively.

In this embodiment, each of the cancellation circuits 872, 874, and 876 are set to slightly different settings allowing nulling of the transmit signal contained within the detected signal with both wider and deeper nulls in the effective filter profile of the cancellation circuit. Alternatively where multiple strong interference signals are received the multiple cancellation circuits 8772, 874, and 876 are optionally individually tuned for each of the multiple interference signals. Optionally the second splitter 850 may be replaced with a dynamic splitter such that the portion of filter WiFi signal provided to each cancellation circuit 872, 874 and 876 may be adjusted, allowing management fo the circuit for overall power consumption. Optionally, the multiple summation node circuits 862, 864 and 866 may be replaced with a single combiner or summing circuit.

It is apparent to one skilled in the art that the invention provides an alternative approach for removing interference within systems where filtering cannot be provided due to the complexities of implementing the filter. It would also be apparent that whilst the exemplary embodiments including filtering elements for separating a WiFi signal from the WiMAX signals that such filtering may be removed such that a specific WiFi channel or sub-set of WiFi channels can be cancelled with WiMAX signals within the WiFi frequency range.

As is evident many alternative configurations of transmitters, receivers, transceivers, antenna, multiple standards etc are possible. It is further apparent that the multiple standards are any of a number of particular combinations of wireless standards, including but not limited to GSM/GPRS at 850 MHz, 900 MHz, 1800 MHz, and 1900 MHz, IEEE 802.11 systems of any variant for WiFi, IEEE 802.16 systems of any variant for WiMAX, IEEE 802.15 systems or variants for ZigBee, wireless USB, Bluetooth™, DECT, Wireless Distribution System, and DSRC. Additionally the wireless systems being cancelled or enhanced by the adoption of active cancellation are optionally other non-wireless communications systems such as microwave ovens—emitting typically at 2450 MHz, RFID tags, global positioning systems (GPS and Galileo), and global navigation satellite systems (GNSS).

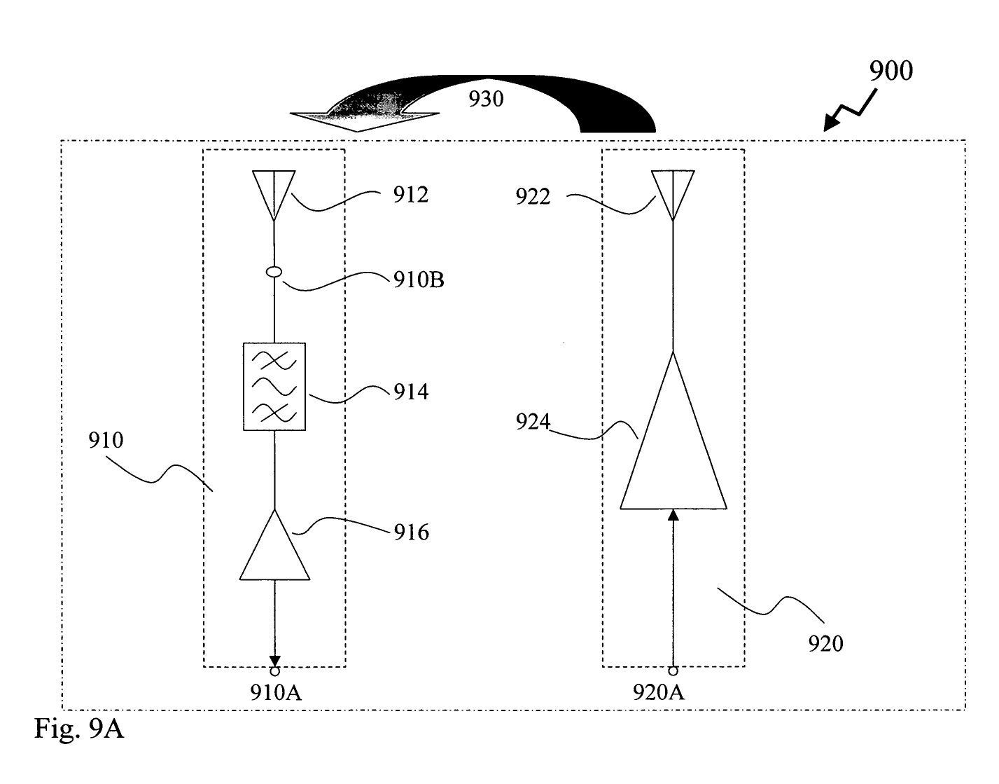

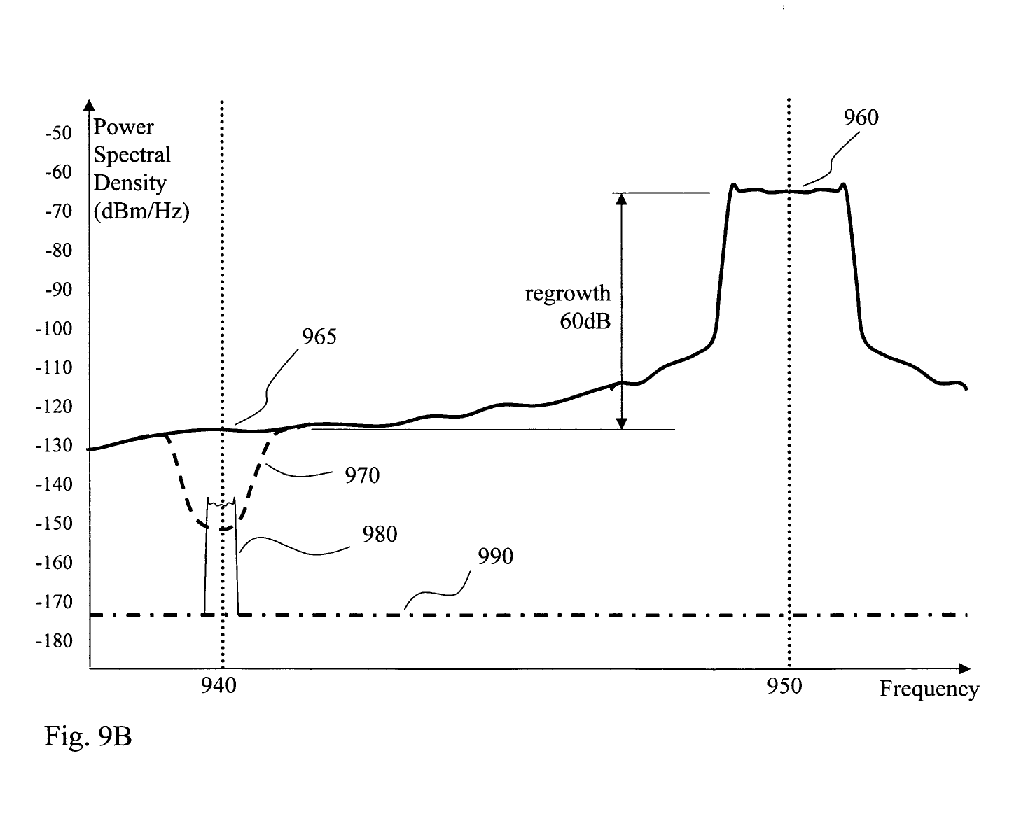

Though it may seem that the lowest frequency band for WiMAX according to IEEE 802.16e of 2300-2600 MHz is quite far from the GNSS bands of 1575±2 MHz (GPS) and 1575±4 MHz (Galileo) the GNSS signals are extremely low power, in fact the signals are typically within the noise and GNSS receivers rely on correlation gain to extract the signal from the noise. As a result a further 25 dB of attenuation in the splatter from active cancellation is beneficial in minimizing the time needed to acquire the low level GNSS signal with correlation gain against the backdrop of noise. Such an exemplary embodiment is described subsequently in respect of FIGS. 9A and 9B.

Shown in FIG. 9A is a WiMAX transmitter 920 and a co-located GPS receiver 910 within a device 900. As shown the WiMAX transmitter comprises an RF input port 920A for receiving a WiMAX transmit signal according to IEEE 802.16e having a centre frequency at the 2400 MHz. The RF input port 920A is electrically coupled to the power amplifier 924 which amplifies the WiMAX transmit signal ready for broadcasting from the antenna 922, in this exemplary embodiment with a transmit power of +24 dBm.

The GPS receiver 910 comprises a receiving antenna 912, which being a broadband antenna receives the intended GPS signal and leakage from the WiMAX transmitter 920 as represented by the crosstalk path 930. The electrical signal from the GPS receiver 910 is coupled to a narrow passband filter 914, which for the GPS standard would have a passband from 1574-1576 MHz. The filtered signal from the narrow passband filter 914 is then coupled to the GPS low noise amplifier 916 and provided to the RF output port 910A of the GPS receiver.

FIG. 9B illustrates an exemplary power spectrum seen at measurement node 910B of the GPS receiver 910 for the embodiment of actively cancelling the leakage between the WiMAX transmitter 920 and GPS receiver 910 wherein the crosstalk path 930 attenuates the transmitted signal by 20 dB. Shown within FIG. 9B is first marker 940 representing the centre frequency 1575 MHz of the GPS receiver 910 and second marker 950 representing the centre frequency 2400 MHz of the WiMAX transmitter 920. The figure plots power spectral density (PSD) as a function of frequency, wherein power spectral density is defined as in equation 8 below.

Power Spectral Density=Power in dBm−10*log(Bandwidth) (8)

Shown in FIG. 9B is the GPS received power spectral density (PSD) curve 980 representing the GPS received signal, and the WiMAX crosstalk PSD curve comprising the WiMAX PSD 960 and regrowth PSD 965. Also shown is the cancelled PSD 970 provided by an active cancellation according to an exemplary embodiment of the invention such as FIG. 8A.

Consider, as an example, that the WiMAX transmitter 920 radiates a transmitted power of +24 dBm within a 10 MHz bandwidth resulting in the WiMAX PSD 960, using Eq. 8 below of −46 dBm/Hz {−46=+24−10log(10e6)}. The 20 dB attenuation of the transmitted signal by way of the crosstalk path 930 results in the GPS receiver receiving a WiMAX PSD 960 at measurement node 910B of −66 dBm/Hz at the second marker 950. The narrow passband filter 914 will filter this signal out, but the WiMAX transmitter regrowth 965 as shown is only 60 dB down from the WiMAX transmit level. As such the regrowth PSD 965 is −126 dBm/Hz, and since it is in-band with the desired GPS signal, represented by GPS receive PSD 980, the narrow passband filter 914 cannot filter it out.

If we consider that the upper in-band signal level for the GPS receiver 910 might be in the range of −80 dBm (corresponding to a GPS receive PSD 980 of −143 dBm/Hz), then the WiMAX regrowth PSD 965 will clearly wipe-out the GPS receiver at it's upper limit!

Now consider that active cancellation is applied between the WiMAX transmitter 920 and GPS receiver 910, and that the cancellation null is placed at the first marker 940 of 1575 MHz with a cancellation depth of 25 dB. Now the cancellation null with transmitter regrowth provides the cancelled PSD 970 of −151 dB/Hz, being −126 dBm/Hz −25 dB, such that the cancelled PSD 970 is now 8 dB below the GPS receive PSD 980 allowing recovery of the GPS signal. Further, as the physical thermal noise floor 990 is −174 dBm/Hz such a system does not place significant restrictions on the noise figure of the GPS low noise amplifier 916, and provides room for improvements in the cancellation null to still manifest themselves within the cancelled PSD 970 and increase operating margin for the GPS receiver 910.

Numerous other embodiments may be envisaged without departing from the spirit or scope of the invention.

What is claimed is:

1. A method comprising;
providing at least a receiver for receiving a first signal according to a first wireless standard, the receiver comprising at least one band-limiting filter of a plurality of band-limiting filters;
receiving at the receiver a second signal according to a second wireless standard;
providing and feeding forward a first cancellation signal, the first cancellation signal being at least a portion of the second signal and having at least one of a predetermined time delay, predetermined amplitude relationship, and predetermined phase relationship with respect to the second signal;
combining the first cancellation signal with the received first signals; and
generating a control signal, the control signal for controlling an aspect of the generation of the first cancellation signal and being generated in dependence upon a measure of the received signal power after filtering thereof by the band-limiting filters.

2. A method according to claim 1 wherein,
providing the first cancellation signal comprises generating a down-converted signal generated at least in dependence upon the portion of the second signal.

3. A method according to claim 2 wherein,
providing the down-converted signal comprises providing the down-converted signal at least one of prior to and after providing at least one of the predetermined time delay, predetermined amplitude relationship, and predetermined phase relationship with respect to the second signal.

4. A method according to claim 1 wherein,
providing the first cancellation signal comprises generating at least one of an in-phase baseband signal and quadrature baseband signal generated at least in dependence upon the portion of the second signal.

5. A method according to claim 4 wherein,
providing the at least one of an in-phase and quadrature baseband signal comprises providing the at least one of an in-phase baseband signal and quadrature baseband signal at least one of prior to and after providing at least one of the predetermined time delay, predetermined amplitude relationship, and predetermined phase relationship with respect to the second signal.

6. A method according to claim 1 wherein,
generating a control signal comprises generating the control signal without dependence upon baseband signals.

7. A method according to claim 1 comprising;
determining a state of a transmitter, the transmitter providing the second signal;
generating the first cancellation signal according to a first state of the transmitter and generating other than the first cancellation signal in a second state of the transmitter.

8. A method according to claim 7 wherein,
determining a state of the transmitter comprises receiving a transmitter enable signal.

9. A method according to claim 7 wherein,
generating other than the first cancellation signal comprises turning off the cancellation circuit.

10. A method according to claim 7 wherein,
generating other than the first cancellation signal comprises generating a second cancellation signal.

11. A method according to claim 10 wherein,
generating the second cancellation signal comprises generating the second cancellation signal according to an aspect of at least one of the first wireless standard and second wireless standard.

12. A method according to claim 7 wherein,
generating other than the first cancellation signal comprises providing a nulling signal, the nulling signal having at least one of a predetermined time delay, predetermined amplitude relationship, and predetermined phase relationship with respect to the transmit signal.

13. A method according to claim 1 wherein,
generating a control signal in dependence upon a measure of the received signal power comprises at least one of measuring the power of the received signal directly and measuring the power of a baseband signal generated from a down-conversion of the received signal.

14. A method according to claim 1 wherein,
providing a receiver according to the first wireless standard comprises providing a receiver according to at least one of IEEE 802.11, IEEE 802.15, IEEE 802.16, IEEE 802.20, UMTS, GSM 850, GSM 900, GSM 1800, GSM 1900, GPRS, Global Navigation Satellite Systems, Global Positioning Systems, Galileo Positioning System, ITU-R 5.138, ITU-R 5.150, and IMT-2000.

15. A method according to claim 1 wherein,
receiving a second signal according to a second wireless standard comprises receiving a second signal having a centre frequency within the frequency range of the first wireless standard.

16. A method according to claim 1 wherein,
providing at least one of a predetermined amplitude relationship and predetermined phase relationship is by providing at least one of a Cartesian modulator and a polar modulator.

17. A method according to claim 1 wherein,
combining the cancellation signal with the received signal comprises providing at least the cancellation signal and received signal to a low noise amplifier summing circuit forming a portion of a receiver circuit operating according to the first wireless standard.

18. A method according to claim 1 wherein,
providing the cancellation signal comprises providing the cancellation signal at least in dependence upon at least an operating characteristic of at least one of the first wireless standard, the second wireless standard, the received first signal and the received second signal.

19. A method according to claim 18 wherein,
an operating characteristic is at least one of a power, a central frequency, a channel number, dynamic range, sensitivity, and bit error rate.

20. A method according to claim 1 wherein,
providing the cancellation signal comprises providing the calibration signal to at least one of reduce the total interfering power from the second signal and increasing at least one of sensitivity and dynamic range of the receiver.

21. A method according to claim 1 wherein,
providing a cancellation signal comprises providing at least one of a passband filter and a tunable filter, the one of the passband filter and tunable filter for rejecting the first signal according to the first wireless standard.

22. A method according to claim 1 wherein,
providing a receiver according to the first wireless standard further comprises providing a first band filter, the first band filter being transmissive to at least signals according to the first wireless standard.

23. A circuit comprising;
at least a receiver for receiving a first signal according to a first wireless standard and a second signal according to a second wireless standard; the receiver comprising at least one band-limiting filter of a plurality of band-limiting filters;
a first cancellation generating circuit for generating and feeding forward a first cancellation signal in response to a control signal, the first cancellation signal being at least a portion of the second signal and having at least one of a predetermined time delay, predetermined amplitude relationship, and predetermined phase relationship with respect to the second signal;
a transmission path for transmitting the first cancellation signal and combining the first cancellation signal with the received first and second signals; and
a control signal output port for providing the control signal for controlling an aspect of the generation of the first cancellation signal and being generated in dependence upon a measure of the received signal power after filtering thereof by the band-limiting filters.

24. A circuit according to claim 23 wherein,
the first cancellation signal generating circuit in generating the first cancellation signal provides a down-converted signal generated at least in dependence upon the portion of the second signal.

25. A circuit according to claim 24 wherein,
the first cancellation signal generating circuit generates the down-converted signal at least one of prior to and after providing at least one of the predetermined time delay, predetermined amplitude relationship, and predetermined phase relationship with respect to the second signal.

26. A circuit according to claim 23 wherein,
the first cancellation signal generating circuit in generating the first cancellation signal provides at least one of an in-phase baseband signal and quadrature baseband signal generated at least in dependence upon the portion of the second signal.

27. A circuit according to claim 26 wherein,
the first cancellation signal generating circuit generates the at least one of an in-phase baseband signal and quadrature baseband signal at least one of prior to and after providing at least one of the predetermined time delay, predetermined amplitude relationship, and predetermined phase relationship with respect to the second signal.

28. A method according to claim 23 wherein,
generating a control signal comprises generating the control signal without dependence upon baseband signals.

29. A circuit according to claim 23 wherein,
the first cancellation signal generating circuit comprises a transmitter enable port, the transmitter enable port for receiving a transmitter enable signal generated at least in dependence upon at least one of the second signal and the transmitter generating the second signal.

30. A circuit according to claim 29 wherein,
the first cancellation signal generating circuit generates the first cancellation signal according to a first state of the transmitter and generates other than the first cancellation signal in a second state of the transmitter.

31. A circuit according to claim 30 wherein,
the first cancellation signal generating circuit in generating the other than the first cancellation signal is turned off.

32. A circuit according to claim 30 wherein,
the first cancellation signal generating circuit in generating the other than the first cancellation signal provides a second cancellation signal according to an aspect of at least one of the first wireless standard and second wireless standard.

33. A method according to claim 30 wherein,
the first cancellation signal generating circuit in generating the other than the first cancellation signal provides a nulling signal, the nulling signal having at least one of a predetermined time delay, predetermined amplitude relationship, and predetermined phase relationship with respect to the transmit signal.

34. A method according to claim 23 comprising,
a detector circuit, the detector circuit connected to the control signal output port and generating a control signal in dependence upon at least one of measuring the power of the received signal directly and measuring the power of a baseband signal generated from a down-conversion of the received signal.

35. A circuit according to claim 23 wherein,
the receiver according to the first wireless standard comprises providing a receiver according to at least one of IEEE 802.11, IEEE 802.15, IEEE 802.16, IEEE 802.20, UMTS, GSM 850, GSM 900, GSM 1800, GSM 1900, GPRS, Global Navigation Satellite Systems, Global Positioning Systems, Galileo Positioning System, ITU-R 5.138, ITU-R 5.150, and IMT-2000.

36. A circuit according to claim 23 wherein,
the second signal according to the second wireless standard comprises a wireless signal having a centre frequency within the frequency range of the first wireless standard.

37. A circuit according to claim 23 comprising;
the first cancellation signal generating circuit comprises providing at least one of a coupler, a bandpass filter, a tunable filter and a cancellation circuit integrated with at least one of a circuit and a receiver circuit.

38. A circuit according to claim 37 wherein,
at least one of the circuit and the receiver circuit comprises providing an integrated circuit being manufactured using a semiconductor technology based upon at least one of silicon, silicon-germanium, gallium arsenide, indium phosphide, gallium nitride and polymers.

39. A circuit according to claim 23 wherein,
the first cancellation signal generating circuit comprises providing at least an integrated circuit, the integrated circuit being manufactured using a semiconductor technology based upon at least one of silicon, silicon-germanium, gallium arsenide, indium phosphide, gallium nitride and polymers.

40. A circuit according to claim 23 wherein,
the first cancellation signal generating circuit comprises providing at least one of a Cartesian modulator and a polar modulator.

41. A circuit according to claim 23 comprising,
a low noise amplifier summing circuit, the low noise amplifier summing circuit having a first input port for receiving the first cancellation signal, a second input port for receiving the received signal, and a sum output port for providing a summed output signal in dependence upon at least the first cancellation signal and received signal.

42. A circuit according to claim 31 wherein,
the low noise amplifier summing circuit forms a portion of the receiver circuit operating according to the first wireless standard.

43. A circuit according to claim 23 wherein,
the first cancellation signal generating circuit provides the first cancellation signal in dependence upon at least an operating characteristic of at least one of the first wireless standard, the second wireless standard, the received first signal and the received second signal.

44. A circuit according to claim 43 wherein,
an operating characteristic is at least one of a power, a central frequency, a channel number, dynamic range, sensitivity, and bit error rate.

45. A circuit according to claim 23 wherein,
the first cancellation signal generating circuit provides at least one of a reduction in the total interfering power from the transmitter within a frequency band according to the first wireless standard and an increase of at least one of sensitivity and dynamic range of the receiver.

46. A circuit according to claim 23 wherein,
the first cancellation signal generating circuit comprises at least one of a passband filter and a tunable filter, the one of the passband filter and tunable filter for rejecting the first signal according to the first wireless standard.

47. A circuit according to claim 23 wherein,
the receiver according to the first wireless standard further comprises a first band filter, the first band filter being transmissive to at least signals according to the first wireless standard.

48. A computer readable medium having stored therein data according to a predetermined computing device format, and upon execution of the data by a suitable computing device a method of improving a receiver is provided, comprising:
providing at least a receiver for receiving a first signal according to a first wireless standard, the receiver comprising at least one band-limiting filter of a plurality of band-limiting filters;
receiving at the receiver a second signal according to a second wireless standard;
providing and feeding forward a first cancellation signal, the first cancellation signal being at least a portion of the second signal and having at least one of a predetermined time delay, predetermined amplitude relationship, and predetermined phase relationship with respect to the second signal;
combining the first cancellation signal with the received first signals; and
generating a control signal, the control signal for controlling an aspect of the generation of the first cancellation signal and being generated in dependence upon a measure of the received signal power after filtering thereof by the band-limiting filters.

49. A computer readable medium according to claim 48 having stored therein data according to a predetermined computing device format, and upon execution of the data by a suitable computing device a method of improving a receiver is provided, comprising:
determining a state of a transmitter, the transmitter providing the second signal;
generating the first cancellation signal according to a first state of the transmitter and generating other than the first cancellation signal in a second state of the transmitter.

50. A computer readable medium according to claim 48 having stored therein data according to a predetermined computing device format, and upon execution of the data by a suitable computing device a method of improving a receiver is provided, comprising:
providing the first cancellation signal comprises generating a down-converted signal generated at least in dependence upon the portion of the second signal.

51. A computer readable medium having stored therein data according to a predetermined computing device format, and upon execution of the data by a suitable computing device a circuit is provided, comprising:
at least a receiver for receiving a first signal according to a first wireless standard and a second signal according to a second wireless standard; the receiver comprising at least one band-limiting filter of a plurality of band-limiting filters;
a first cancellation generating circuit for generating and feeding forward a first cancellation signal in response to a control signal, the first cancellation signal being at least a portion of the second signal and having at least one of a predetermined time delay, predetermined amplitude relationship, and predetermined phase relationship with respect to the second signal;
a transmission path for transmitting the first cancellation signal and combining the first cancellation signal with the received first and second signals; and
a control signal output port for providing the control signal for controlling an aspect of the generation of the first cancellation signal and being generated in dependence upon a measure of the received signal power after filtering thereof by the band-limiting filters.

52. A computer readable medium according to claim 51 having stored therein data according to a predetermined computing device format, and upon execution of the data by a suitable computing device a circuit is provided, comprising:
the first cancellation signal generating circuit comprises a transmitter enable port, the transmitter enable port for receiving a transmitter enable signal generated at least in dependence upon at least one of the second signal and the transmitter generating the second signal.

53. A computer readable medium according to claim 51 having stored therein data according to a predetermined computing device format, and upon execution of the data by a suitable computing device a circuit is provided, comprising:
the first cancellation signal generating circuit in generating the first cancellation signal provides a down-converted signal generated at least in dependence upon the portion of the second signal.
